(19) United States
(12) Patent Application Publication
(10) Pub. No.: US 2011/0219629 A1
(43) Pub. Date: Sep. 15, 2011

(54) Pruning Hook

(76) Inventor: Shih-Piao Wu, Lu Kang Town (TW)

(21) Appl. No.: 12/721,811

(22) Filed: Mar. 11, 2010

(51) Int. Cl. A01G 3/08

(52) U.S. Cl. 30/249; 30/279.2

(57) ABSTRACT

A pruning hook includes an extension pipe, a fixed blade mounted on the extension pipe, a movable blade pivotally connected with the fixed blade, a metallic driving chain connected with the movable blade, a sliding member movably mounted in the extension pipe and connected with the driving chain, a control cord mounted in the extension pipe and connected with the sliding member, and a control sleeve movably mounted on the extension pipe and connected with the control cord. Thus, the driving chain is made of metallic material so that the driving chain has a greater structural stiffness and can directly transmit the pulling force from the control cord without producing a tensile deformation during operation so as to enhancing the working efficiency of the pruning hook.

### BACKGROUND OF THE INVENTION

1. Field of the Invention

The present invention relates to a shearing tool and, more particularly, to a pruning hook for a gardening purpose to shear branches or leaves at a higher location.

2. Description of the Related Art

A conventional pruning hook in accordance with the prior art shown in FIG. 6 comprises an extension pipe 40, a fixed blade 51 mounted on a front end of the extension pipe 40, a movable blade 52 pivotally connected with and movable relative to the fixed blade 51, a pull cord 42 connected with the movable blade 52 to drive the movable blade 52 to move relative to the fixed blade 51, a control sleeve 41 movably mounted on the extension pipe 40 and connected with the pull cord 42 to drive and move the pull cord 42, a guide pulley 54 rotatably mounted on a first end of the movable blade 52 for mounting the pull cord 42, and an elastic member 53 biased between a second end of the movable blade 52 and the fixed blade 51 to drive the movable blade 52 to move outwardly relative to the fixed blade 51. The fixed blade 51 has an inner portion provided with a connecting hole 55 connected to the extension pipe 40 to allow passage of the pull cord 42. The pull cord 42 is pivotally mounted on the guide pulley 54 and extends through the connecting hole 55 of the fixed blade 51 into the extension pipe 40. The pull cord 42 has a first end 420 secured on the fixed blade 51 and a second end 422 secured on the control sleeve 41.

In operation, when the control sleeve 41 is moved outwardly relative to the fixed blade 51, the pull cord 42 is driven by the control sleeve 41 to move the guide pulley 54 which drives the movable blade 52 to move toward the fixed blade 51 so as to perform a cutting action. On the contrary, when the pulling force applied on the control sleeve 41 is removed, the movable blade 52 is driven by the restoring force of the elastic member 53 to move outwardly relative to the fixed blade 51 so that the movable blade 52 and the fixed blade 51 are opened at a normal state.

However, when the object to be cut by the movable blade 52 and the fixed blade 51 is too large or hard, the pull cord 42 cannot withstand the larger pulling force applied by the user, so that the pull cord 42 is easily deformed by the tensile force and cannot directly transmit the pulling force to the movable blade 52, thereby decreasing the working efficiency of the movable blade 52. In addition, the pull cord 42 is exposed from the fixed blade 51 so that when the pull cord 42 is hooked or scratched by foreign objects, such as branches and the like, during operation, the pull cord 42 will be torn or broken due to an external force caused by the foreign objects.

### BRIEF SUMMARY OF THE INVENTION

In accordance with the present invention, there is provided a pruning hook, comprising an extension pipe, a fixed blade having an end portion mounted on a front end of the extension pipe, a movable blade pivotally connected with and movable relative to the fixed blade, a metallic driving chain connected with the movable blade to drive the movable blade to move relative to the fixed blade, a hollow sliding member movably mounted in the extension pipe and connected with the driving chain to drive and move the driving chain, a control cord mounted in the extension pipe and connected with the sliding member to drive and move the sliding member relative to the extension pipe, a control sleeve movably mounted on the extension pipe and connected with the control cord to drive and move the control cord relative to the extension pipe, a first guide pulley rotatably mounted on a first end of the movable blade, an elastic member biased between a second end of the movable blade and the fixed blade to drive the movable blade to move outwardly relative to the fixed blade, a second guide pulley rotatably mounted on the fixed blade, and a fixing seat secured in a rear end of the extension pipe.

The extension pipe has an inner portion provided with a receiving chamber to receive the driving chain, the sliding member and the control cord. The extension pipe has a side provided with an opening connected to the receiving chamber to allow passage of the control cord. The control cord has a first end extending from the extension pipe and secured in the control sleeve to move in concert with the control sleeve and has a second end secured in the fixing seat. The fixed blade has a side provided with a fixing hole and has an inner portion provided with a connecting hole connected to the receiving chamber of the extension pipe to allow passage of the driving chain. The driving chain is pivotally mounted on the first guide pulley to drive the movable blade to move toward the fixed blade. The driving chain passes through the second guide pulley and extends through the connecting hole of the fixed blade into the receiving chamber of the extension pipe. The driving chain has a first end secured in the fixing hole of the fixed blade and a second end secured in the sliding member to move in concert with the sliding member.

According to the primary objective of the present invention, the driving chain is made of metallic material so that the driving chain has a greater structural stiffness and can directly transmit the pulling force from the control cord without producing a tensile deformation during operation so as to enhancing the working efficiency of the pruning hook.

According to another objective of the present invention, only the driving chain is exposed from the extension pipe, so that when the driving chain is hooked or scratched by foreign objects, such as branches and the like, during operation, the driving chain made of metallic material will not be torn or broken due to an external force caused by the foreign objects so as to enhance the lifetime of the pruning hook.

According to a further objective of the present invention, the control cord is guided by the control pulley, and the driving chain is guided by the first guide pulley and the second guide pulley so that the control cord and the driving chain are operated smoothly and stably to facilitate operation of the pruning hook.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a pruning hook in accordance with the preferred embodiment of the present invention.

FIG. 2 is an exploded perspective view of the pruning hook as shown in FIG. 1.

FIG. 3 is a perspective broken view of the pruning hook as shown in FIG. 1.

FIG. 4 is a side cross-sectional view of the pruning hook as shown in FIG. 1.

FIG. 5 is a locally enlarged operational view of the pruning hook as shown in FIG. 4 in use.

FIG. 6 is a side view of a conventional pruning hook in accordance with the prior art.

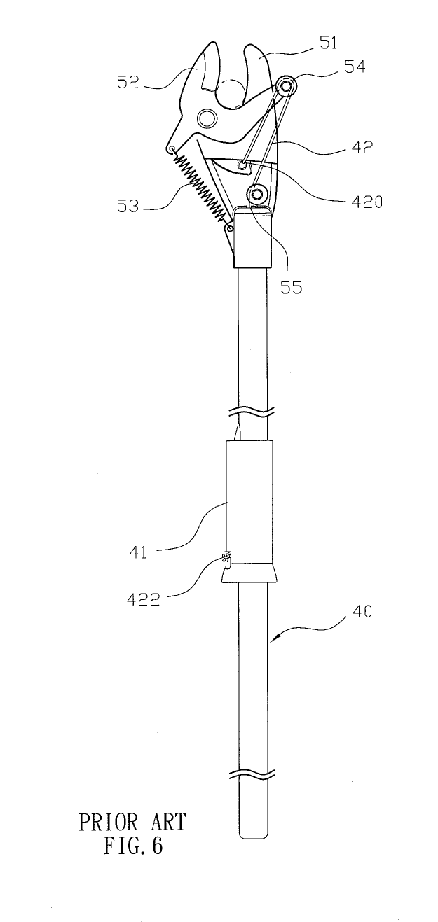

### DETAILED DESCRIPTION OF THE INVENTION

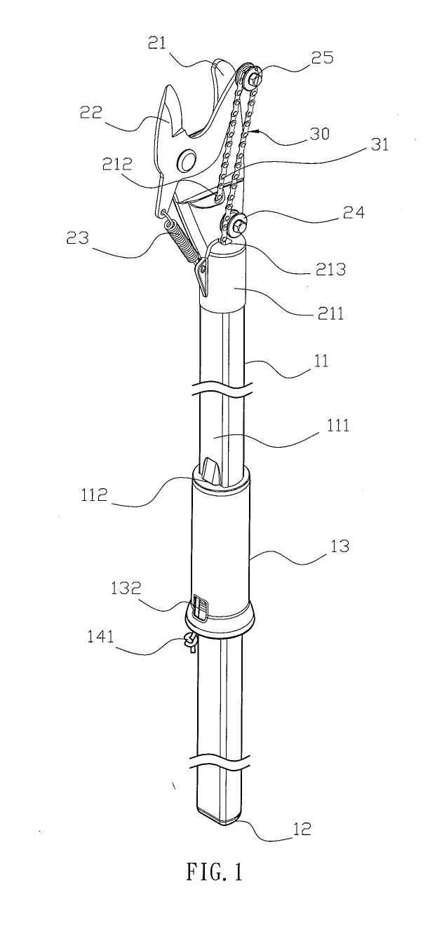

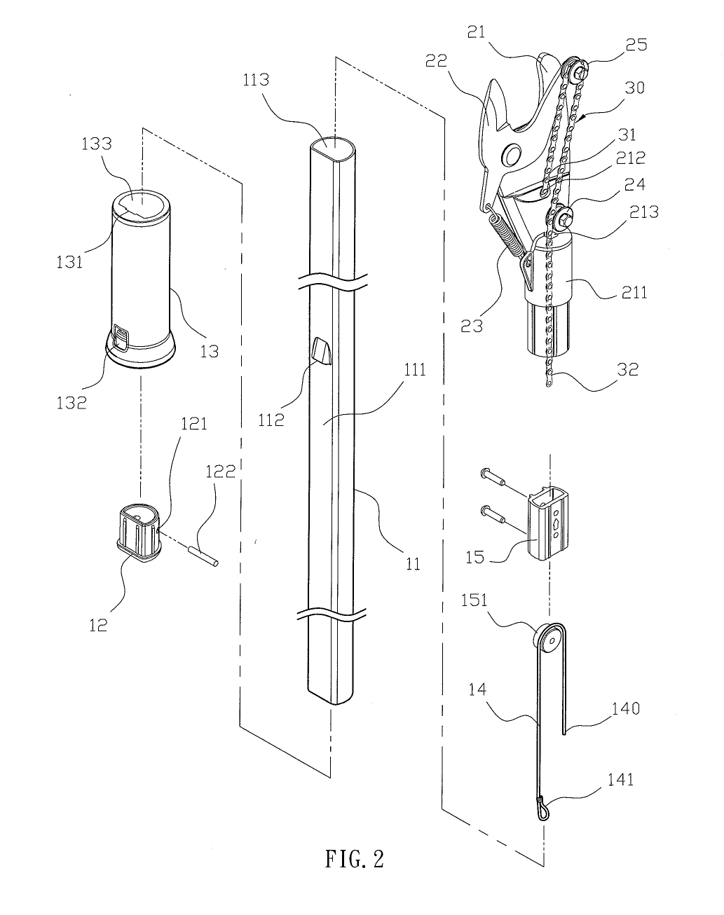

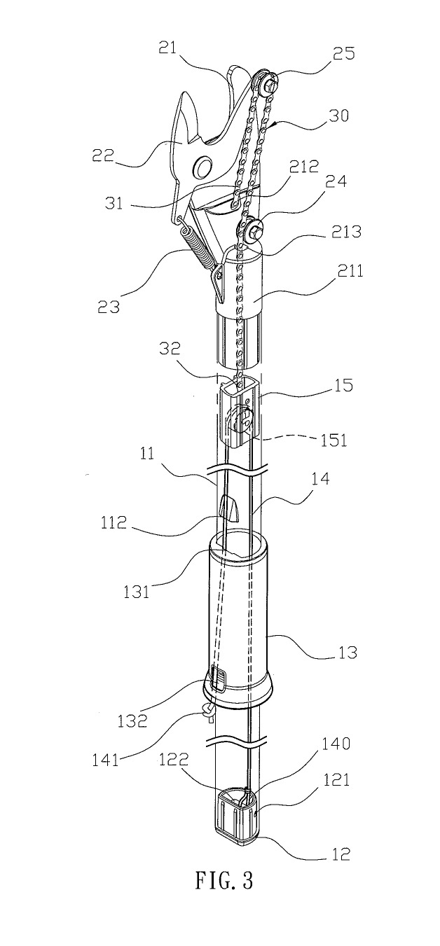

Referring to the drawings and initially to FIGS. 1-4, a pruning hook in accordance with the preferred embodiment of the present invention comprises an extension pipe 11, a fixed blade 21 having an end portion 211 mounted on a front end of the extension pipe 11, a movable blade 22 pivotally connected with and movable relative to the fixed blade 21, a metallic driving chain 30 connected with the movable blade 22 to drive the movable blade 22 to move relative to the fixed blade 21, a hollow sliding member 15 movably mounted in the extension pipe 11 and connected with the driving chain 30 to drive and move the driving chain 30, a control cord 14 mounted in the extension pipe 11 and connected with the sliding member 15 to drive and move the sliding member 15 relative to the extension pipe 11, and a control sleeve 13 movably mounted on the extension pipe 11 and connected with the control cord 14 to drive and move the control cord 14 relative to the extension pipe 11.

The pruning hook further comprises a first guide pulley 25 rotatably mounted on a first end of the movable blade 22, an elastic member 23 biased between a second end of the movable blade 22 and the fixed blade 21 to drive the movable blade 22 to move outwardly relative to the fixed blade 21, a second guide pulley 24 rotatably mounted on the fixed blade 21, a control pulley 151 rotatably mounted in the sliding member 15, and a fixing seat 12 secured in a rear end of the extension pipe 11.

The extension pipe 11 has an inner portion provided with a receiving chamber 113 to receive the driving chain 30, the sliding member 15 and the control cord 14. The extension pipe 11 has a side provided with an opening 112 connected to the receiving chamber 113 to allow passage of the control cord 14. The extension pipe 11 has a semi-circular cross-sectional profile and has a flattened face 111. The opening 112 of the extension pipe 11 is formed in the flattened face 111 of the extension pipe 11.

The fixing seat 12 is secured in the receiving chamber 113 of the extension pipe 11. The fixing seat 12 has two side walls each provided with a pin hole 121 to allow passage of a fixing pin 122.

The control cord 14 is partially received in the sliding member 15 and is pivotally mounted on the control pulley 151 to drive and move the control pulley 151 and the sliding member 15 relative to the extension pipe 11. The control cord 14 has a first end 141 extending from the extension pipe 11 and secured in the control sleeve 13 to move in concert with the control sleeve 13 and has a second end 140 secured in the fixing seat 12. The first end 141 of the control cord 14 passes through and protrudes outwardly from the opening 112 of the extension pipe 11. The second end 140 of the control cord 14 is secured on the fixing pin 122 so that the second end 140 of the control cord 14 is attached to the fixing seat 12.

The control sleeve 13 has an inner portion provided with a slideway 133 slidably mounted on the extension pipe 11. The slideway 133 of the control sleeve 13 has a substantially semi-circular cross-sectional profile. The control sleeve 13 has a side provided with a guide channel 131 connected to the slideway 133 to allow passage of the control cord 14. The guide channel 131 of the control sleeve 13 extends in a longitudinal direction of the control sleeve 13. The control sleeve 13 has a periphery provided with a fixing portion 132 connected to the guide channel 131 to fix the first end 141 of the control cord 14 so that the first end 141 of the control cord 14 is secured on the control sleeve 13. The control sleeve 13 is located outside of the extension pipe 11 and disposed between the opening 112 of the extension pipe 11 and the fixing seat 12 so that the opening 112 of the extension pipe 11 can limit a further movement of the control sleeve 13.

The fixed blade 21 has a side provided with a fixing hole 212 and has an inner portion provided with a connecting hole 213 connected to the receiving chamber 113 of the extension pipe 11 to allow passage of the driving chain 30. The second guide pulley 24 is located beside the connecting hole 213 of the fixed blade 21.

The driving chain 30 is pivotally mounted on the first guide pulley 25 to drive the movable blade 22 to move toward the fixed blade 21. The driving chain 30 passes through the second guide pulley 24 and extends through the connecting hole 213 of the fixed blade 21 into the receiving chamber 113 of the extension pipe 11. The driving chain 30 has a first end 31 secured in the fixing hole 212 of the fixed blade 21 and a second end 32 secured in the sliding member 15 to move in concert with the sliding member 15. The driving chain 30 co-operates with the control cord 14 to function as a driving mechanism to drive the movable blade 22.

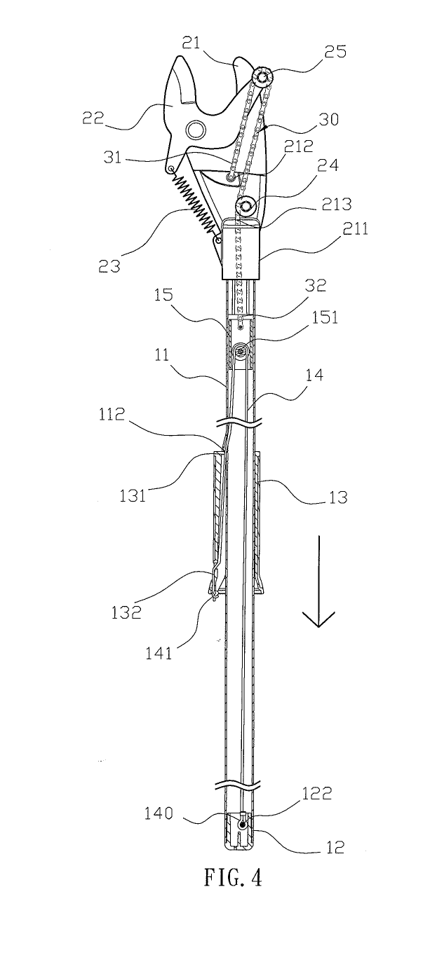

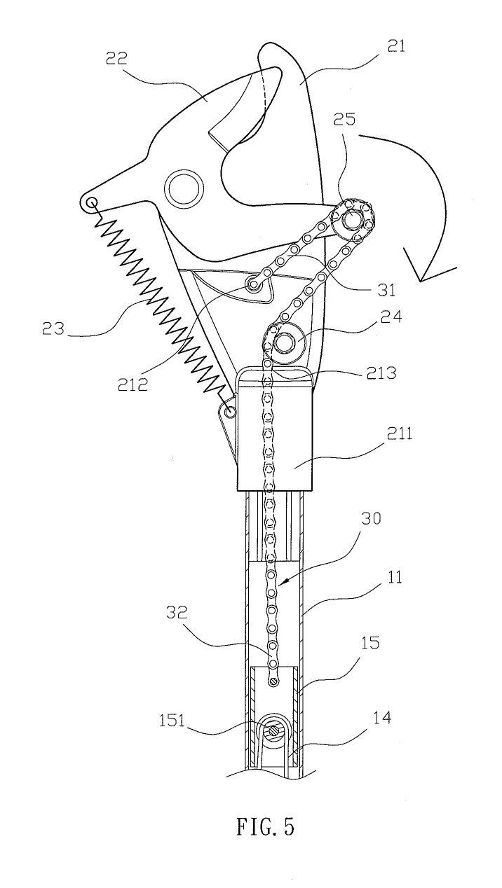

In operation, referring to FIGS. 4 and 5 with reference to FIGS. 1-3, when the control sleeve 13 is moved outwardly relative to the fixed blade 21, the control cord 14 is driven by the control sleeve 13 to move the control pulley 151 which moves the sliding member 15 which moves the driving chain 30 which moves the first guide pulley 25 which drives the movable blade 22 to move toward the fixed blade 21 as shown in FIG. 5 so as to perform a cutting action. On the contrary, when the pulling force applied on the control sleeve 13 is removed, the movable blade 22 is driven by the restoring force of the elastic member 23 to move outwardly relative to the fixed blade 21 as shown in FIG. 4 so that the movable blade 22 and the fixed blade 21 are opened at a normal state. At this time, the control sleeve 13 is limited by the opening 112 of the extension pipe 11.

Accordingly, the driving chain 30 is made of metallic material so that the driving chain 30 has a greater structural stiffness and can directly transmit the pulling force from the control cord 14 without producing a tensile deformation during operation so as to enhancing the working efficiency of the pruning hook. In addition, only the driving chain 30 is exposed from the extension pipe 11, so that when the driving chain 30 is hooked or scratched by foreign objects, such as branches and the like, during operation, the driving chain 30 made of metallic material will not be torn or broken due to an external force caused by the foreign objects so as to enhance the lifetime of the pruning hook. Further, the control cord 14 is guided by the control pulley 151, and the driving chain 30 is guided by the first guide pulley 25 and the second guide pulley 24 so that the control cord 14 and the driving chain 30 are operated smoothly and stably to facilitate operation of the pruning hook.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A pruning hook, comprising:
an extension pipe;
a fixed blade having an end portion mounted on a front end of the extension pipe;
a movable blade pivotally connected with and movable relative to the fixed blade;
a metallic driving chain connected with the movable blade to drive the movable blade to move relative to the fixed blade;
a hollow sliding member movably mounted in the extension pipe and connected with the driving chain to drive and move the driving chain;
a control cord mounted in the extension pipe and connected with the sliding member to drive and move the sliding member relative to the extension pipe;
a control sleeve movably mounted on the extension pipe and connected with the control cord to drive and move the control cord relative to the extension pipe;
a first guide pulley rotatably mounted on a first end of the movable blade;
an elastic member biased between a second end of the movable blade and the fixed blade to drive the movable blade to move outwardly relative to the fixed blade;
a second guide pulley rotatably mounted on the fixed blade; and
a fixing seat secured in a rear end of the extension pipe;
wherein the extension pipe has an inner portion provided with a receiving chamber to receive the driving chain, the sliding member and the control cord;
the extension pipe has a side provided with an opening connected to the receiving chamber to allow passage of the control cord;
the control cord has a first end extending from the extension pipe and secured in the control sleeve to move in concert with the control sleeve and has a second end secured in the fixing seat;
the fixed blade has a side provided with a fixing hole and has an inner portion provided with a connecting hole connected to the receiving chamber of the extension pipe to allow passage of the driving chain;
the driving chain is pivotally mounted on the first guide pulley to drive the movable blade to move toward the fixed blade;
the driving chain passes through the second guide pulley and extends through the connecting hole of the fixed blade into the receiving chamber of the extension pipe;
the driving chain has a first end secured in the fixing hole of the fixed blade and a second end secured in the sliding member to move in concert with the sliding member.

2. The pruning hook of claim 1, wherein
the extension pipe has a substantially semi-circular cross-sectional profile and has a flattened face;
the opening of the extension pipe is formed in the flattened face of the extension pipe;
the slideway of the control sleeve has a substantially semi-circular cross-sectional profile.

3. The pruning hook of claim 1, wherein
the first end of the control cord passes through and protrudes outwardly from the opening of the extension pipe;
the control sleeve has an inner portion provided with a slideway slidably mounted on the extension pipe;
the control sleeve has a side provided with a guide channel connected to the slideway to allow passage of the control cord;
the control sleeve has a periphery provided with a fixing portion connected to the guide channel to fix the first end of the control cord so that the first end of the control cord is secured on the control sleeve.

4. The pruning hook of claim 1, wherein
the fixing seat is secured in the receiving chamber of the extension pipe;
the fixing seat has two side walls each provided with a pin hole to allow passage of a fixing pin;
the second end of the control cord is secured on the fixing pin so that the second end of the control cord is attached to the fixing seat.

5. The pruning hook of claim 1, wherein
the pruning hook further comprises a control pulley rotatably mounted in the sliding member;
the control cord is pivotally mounted on the control pulley to drive and move the control pulley and the sliding member relative to the extension pipe.
